(19) United States
(12) Patent Application Publication
(10) Pub. No.: US 2005/0034589 A1
(43) Pub. Date: Feb. 17, 2005

(54) Percussion instrument

(76) Inventor: Gil Maoz, Gan Yavne (IL)

Correspondence Address: Dekel Patent Ltd.;Beit HaRof'im, 18 Menuha VeNahala Street, Room 27, Rehovot, IL

(21) Appl. No.: 10/912,121

(22) Filed: Aug. 6, 2004

Related U.S. Application Data
(60) Provisional application No. 60/493,816, filed on Aug. 11, 2003.

(51) Int. Cl. G10D 3/18

(52) U.S. Cl. 84/328

(57) ABSTRACT

A percussion instrument including a percussion sound source connected to a forearm holder which is adapted for attachment to a forearm of a user.

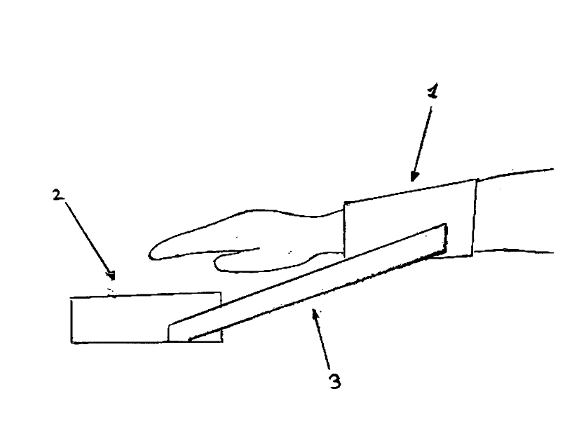

### CROSS-REFERENCE TO RELATED APPLICATIONS

This application claims priority under 35 USC §119 to U.S. Provisional Patent Application Ser. No. 60/493,816, filed on Aug. 11, 2003, which is incorporated herein by reference.

### FIELD OF THE INVENTION

This invention relates generally to percussion instruments.

### BACKGROUND OF THE INVENTION

Many percussion instruments are known. In general such instruments are placed on stands supported on a floor.

### SUMMARY OF THE INVENTION

The present invention seeks to provide a drumming/percussion instrument that opens up new possibilities in the world of drumming and percussion. The instrument may give the percussionist a bigger range of playing and performance abilities. The invention may give the percussionist an almost absolute freedom of movement while he plays the instrument.

The invention creates new opportunities for stage artists that can combine movement and rhythm that is created simultaneously by one person. The invention allows dancing, running or any other movement while creating rhythm.

The invention can be used in parades or big stadium shows where arm movement is important, and also the amateur market for people that are interested in a combination of movement and rhythm.

### BRIEF DESCRIPTION OF THE DRAWINGS

The present invention will be understood and appreciated more fully from the following detailed description taken in conjunction with the appended drawing which is a simplified pictorial illustration of a percussion instrument, constructed and operative in accordance with an embodiment of the present invention.

### DETAILED DESCRIPTION OF EMBODIMENTS

Referring to the drawing, the percussion instrument may include a percussion sound source 2 connected to a forearm holder 1 which is adapted for attachment to a forearm of a user. Percussion sound source 2 may be constructed of any rigid, semi-rigid or flexible sheet or membrane that vibrates when struck. The percussion sound source 2 may be stretched taut over a frame and may be tunable.

The forearm holder 1 enables putting on and taking off the instrument relatively quickly. The forearm holder 1 may be a flexible or semi-flexible sleeve that is worn on the hand or forearm, or a stiff/semi-stiff structure that is secured to the hand using any kind of locking mechanism (for example, strap, belt, clips, etc.).

It is noted that the term “forearm” as used throughout the specification and claims refers to any part of the arm from the palm and fingers to the shoulder, inclusive.

The percussion sound source 2 may be connected directly to the forearm holder 1. Alternatively, as shown in the drawing, the percussion sound source 2 may be connected to forearm holder 1 by an elongate extension arm 3. The elongate extension arm 3 may be constructed of any suitable material, rigid or flexible, such as metal or plastic. The attachment of each of the percussion sound source 2 and the forearm holder 1 to the elongate extension arm 3 may be adjustable (e.g., by means of mechanical fasteners).

The percussion instrument is a lightweight instrument that may be attached to a forearm of a user with forearm holder 1, such that the percussion sound source 2 may be struck, strum or tapped by the palm or fingers of the hand. It is possible to attach the instrument to both hands (one for each hand) for simultaneously drumming with both hands. Each hand can move freely in space without limitation and without any dependency to the other hand. Due to the fact that the instrument is constantly attached to the hand, the percussion instrument follows the palm movement (wherever it is) and therefore it is always possible to tap/strike it with the palm.

The instrument can be made from one material or different materials. It can be made as one piece or from different parts combined into one product.

The instrument may be constructed to provide a range of movement between the palm and the percussion sound source 2 or other parts of the instrument. This range of movement provides the percussionist the ability to intensify the tapping/striking sound. The range of movement may be created due to the flexibility or some looseness of the forearm holder 1 or elongate extension arm 3.

It is appreciated that various features of the invention which are, for clarity, described in the contexts of separate embodiments, may also be provided in combination in a single embodiment. Conversely, various features of the invention which are, for brevity, described in the context of a single embodiment, may also be provided separately or in any suitable subcombination.

1. A percussion instrument comprising a percussion sound source connected to a forearm holder which is adapted for attachment to a forearm of a user.

2. The percussion instrument according to claim 1, wherein said percussion sound source is connected to said forearm holder by an elongate extension arm.

3. The percussion instrument according to claim 2, wherein said percussion sound source is adjustably connected to said elongate extension arm.

4. The percussion instrument according to claim 2, wherein said forearm holder is adjustably connected to said elongate extension arm.

5. The percussion instrument according to claim 2, wherein said elongate extension arm is rigid.

6. The percussion instrument according to claim 2, wherein said elongate extension arm is flexible.
